(19) United States
(12) Patent Application Publication
(10) Pub. No.: US 2021/0334877 A1
(43) Pub. Date: Oct. 28, 2021

(54) SYSTEM AND METHOD FOR FASHION STYLE RECOMMENDATION

(71) Applicants: JINGDONG DIGITS TECHNOLOGY HOLDING CO., LTD., Beijing (CN); JD FINANCE AMERICA CORPORATION, Wilmington, DE (US)

(72) Inventors: Jui-Hsin Lai, Mountain View, CA (US); Guanghan Ning, Sunnyvale, CA (US); Guifang Dong, Beijing (CN); Jia Lin, Mountain View, CA (US); Zijing Zou, Beijing (CN); Chi Zhang, Fremont, CA (US)

(21) Appl. No.: 16/859,165

(22) Filed: Apr. 27, 2020

(51) Int. Cl. G06Q 30/06; G06F 16/9535; G06F 16/906; G06F 16/532; G06N 3/08; G06K 9/62; G06K 9/46

(52) U.S. Cl. CPC G06Q 30/0631; G06F 16/9535; G06F 16/906; G06F 16/532; G06Q 30/0627; G06K 9/4652; G06Q 30/0643; G06N 3/08; G06K 9/6215; G06K 9/4642; G06Q 30/0629

(57) ABSTRACT

A system and a method for recommending a set of fashion items. The method includes: providing fashion categories, fashion graphs each corresponding to one fashion category, and fitting formulas for each fashion graph; receiving a query fashion item having a query fashion attribute; selecting a fashion category, where the query fashion attribute in the selected fashion category has a highest number of fashion items; performing a similarity search between image of the query fashion item and images of fashion items in the fitting formulas; mapping the searched fitting formula to the fashion graph of the selected fashion category to obtain nodes matching the fashion items in the searched fitting formula; and recommending the set of fashion items respectively selected from fashion items in the matched nodes. The fitting formulas are generated based on co-appearance of fashion items from any two nodes of the corresponding fashion graph.

### CROSS-REFERENCES

Some references, which may include patents, patent applications and various publications, are cited and discussed in the description of this invention. The citation and/or discussion of such references is provided merely to clarify the description of the present disclosure and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present disclosure relates generally to recommending fashion items having the same fashion style, and more particularly to a system and method for recommending dresses and other fashion items with compatible fashion style based on graph analysis and visual similarity.

### BACKGROUND OF THE INVENTION

The background description provided herein is for the purpose of generally presenting the context of the invention. Work of the presently named inventors, to the extent it is described in this background section, as well as aspects of the description that may not otherwise qualify as prior art at the time of filing, are neither expressly nor impliedly admitted as prior art against the present disclosure.

With the growing popularity of e-commerce, a large number of products are available for consumers, especially fashion products. Although a professional can recommend a set of dresses fit with each other to a customer, it is challenging for a customer to make his selections starting from one dress that he is interested in.

Therefore, an unaddressed need exists in the art to address the aforementioned deficiencies and inadequacies.

### SUMMARY OF THE INVENTION

In certain aspects, the present disclosure relates to a method for recommending a set of fashion items. In certain embodiments, the method includes:

providing, by a computing device, a plurality of fashion categories, where each of the fashion categories includes a plurality of fashion attributes, and each of the fashion attributes has a frequency value representing a number of fashion items contained in the attribute;

providing, by the computing device, a fashion graph corresponding to each of the fashion categories, where nodes of the fashion graph correspond to the fashion attributes of the fashion category, and each edge of the fashion graph has a co-appearance value representing a number of co-appearance of the fashion items from two of the nodes connected by the edge;

providing, by the computing device, a plurality of fitting formulas for each of the fashion categories, each of the fitting formulas including a number of fashion items;

receiving, by the computing device, a query fashion item;

selecting, by the computing device, one of the fashion categories as a selected fashion category, where the query fashion item corresponds to a query fashion attribute, the frequency value of the query fashion attribute in the selected fashion category is greater than the frequency value of the query fashion attribute in the other of the fashion categories;

performing, by the computing device, a similarity search between image of the query fashion item and images of the fashion items in the fitting formulas of the selected fashion category, to obtain at least one searched fitting formula, the image of the query fashion item and one of the images of the fashion items in the searched fitting formulas having a highest image similarity;

mapping, by the computing device, the searched fitting formula to the fashion graph of the selected fashion category to obtain matched nodes, the matched nodes corresponding to the fashion items in the searched fitting formula; and

recommending, by the computing device, the set of fashion items, where each of the set of fashion items is selected from a plurality of fashion items in one of the matched nodes.

In certain embodiments, the fashion categories, the fashion graphs, and the fitting formulas are provided by:

retrieving fitting combinations, each fitting combination including a plurality of fashion items compatible with each other;

aggregating the fashion items from the fitting combinations according to their fashion styles or fashion occasions to obtain the fashion categories, each of the fashion categories corresponding to one of the fashion styles or fashion occasions;

constructing the fashion graphs from the fashion categories by converting the fashion attributes in the fashion categories to the nodes in the fashion graph, and calculating the co-appearance value between the nodes to characterize the edges; and

generating the fitting formulas based on co-appearance values in corresponding one of the fashion graph.

In certain embodiments, the fashion styles include sports style, casual style, office style, Japanese style, Korea style, western style, British style, girly, and punk, and the fashion occasions include dating occasion, travel occasion, party occasion, family occasion, and wedding occasion.

In certain embodiments, the attributes include skirts, pants, shirt, T-shirt, sweater, cardigan, boat neck, sports bag, clutch, tote, satchel, bucket bag, briefcase, and accessories.

In certain embodiments, the fashion items in the attributes of the fashion categories are characterized by their identifications, images, prices, styles and attributes. In certain embodiments, the identifications are stock keeping units (SKUs). In certain embodiments, the identifications, images, prices, styles and attributes of the fashion items are represented by a vector having a plurality of dimensions.

In certain embodiments, the similarity search is performed using color histogram.

In certain embodiments, the step of selecting one of the fashion categories as the selected fashion category is performed by convolutional neural network (CNN) using the image of the query fashion item.

In certain embodiments, each of the fitting formulas includes at least three fashion items, and each of the at least three fashion items exclusively corresponds to one of a top wear, a bottom wear, an outwear, a pair of shoes, and an accessory.

In certain aspects, the present disclosure relates to a system for recommending a set of fashion items. In certain embodiments, the system includes a computing device, the computing device has a processor and a storage device storing computer executable code. The computer executable code, when executed at the processor, is configured to perform the method described above.

In certain aspects, the present disclosure relates to a non-transitory computer readable medium storing computer executable code. The computer executable code, when executed at a processor of a computing device, is configured to perform the method described above.

These and other aspects of the present disclosure will become apparent from following description of the preferred embodiment taken in conjunction with the following drawings and their captions, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 schematically illustrates a system for compatible fashion item recommendation according to certain embodiments of the present disclosure.

FIG. 2A schematically illustrates a fashion database construction application according to certain embodiments of the present disclosure.

FIG. 2B schematically illustrates a fashion item compatibility database according to certain embodiments of the present disclosure.

FIG. 2C schematically illustrates a fashion item recommendation application according to certain embodiments of the present disclosure.

FIG. 3A schematically illustrates a fitting combination according to certain embodiments of the present disclosure.

FIGS. 3B and 3C schematically illustrate compiled data files, where the data is extracted from fitting combinations and product databases according to certain embodiments of the present disclosure.

FIGS. 4A and 4B schematically illustrate fashion categories according to certain embodiments of the present disclosure.

FIGS. 5A-5C schematically illustrate fashion graphs according to certain embodiments of the present disclosure.

FIG. 6 schematically illustrates generation of fitting formulas from a fashion graph according to certain embodiments of the present disclosure.

FIG. 7A schematically illustrates determination of a fashion category based on a query fashion item according to certain embodiments of the present disclosure.

FIG. 7B schematically illustrates matching a fashion item to multiple fitting formulas using visual search according to certain embodiments of the present disclosure.

FIG. 7C schematically illustrates mappings of fitting formulas to a fashion graph according to certain embodiments of the present disclosure.

FIG. 7D schematically illustrates selecting of a fashion item from multiple similar fashion items through fashion graph according to certain embodiments of the present disclosure.

FIG. 7E schematically illustrates selecting a set of fashion items based on a fashion graph according to certain embodiments of the present disclosure.

FIG. 8 schematically illustrates a method for constructing fashion item compatibility database according to certain embodiments of the present disclosure.

FIG. 9 schematically illustrates a method for recommending a set of fitting combination using fashion item compatibility database according to certain embodiments of the present disclosure.

### DETAILED DESCRIPTION OF THE INVENTION

The present disclosure is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “plurality” means two or more. As used herein, the terms “comprising,” “including,” “carrying,” “having,” “containing,” “involving,” and the like are to be understood to be open-ended, i.e., to mean including but not limited to.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this invention will be thorough and complete, and will fully convey the scope of the present disclosure to those skilled in the art.

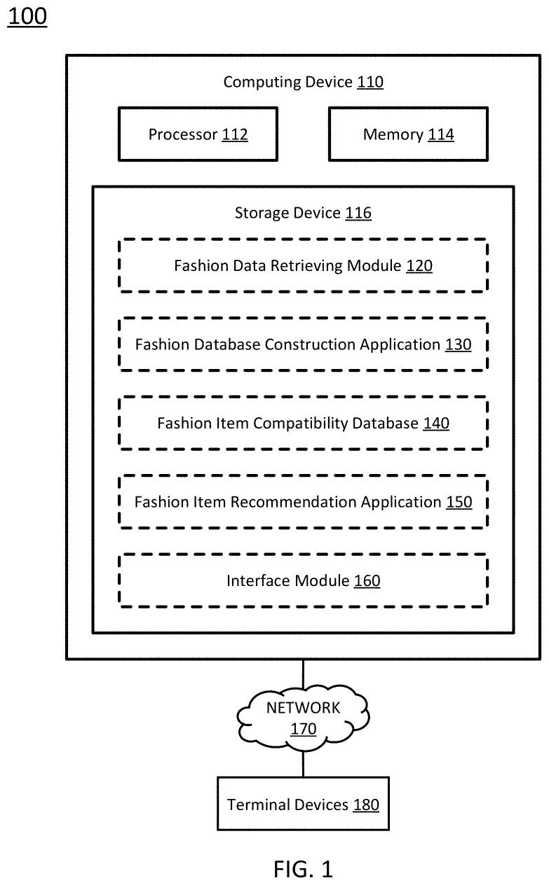

In accordance with the purposes of the present disclosure, as embodied and broadly described herein, in certain aspects, the present disclosure relates to a system for recommending fashion items that are compatible with each other. FIG. 1 schematically depicts a system 100 according to certain embodiments of the present disclosure. As shown in FIG. 1, the system 100 includes a computing device 110, one or more terminal devices 180, and a network 170 communicatively connecting the computing device 110 with the terminal devices 180.

In certain embodiments, the computing device 110 may be a server computer, a cluster, a cloud computer, a general-purpose computer, a headless computer, or a specialized computer, which provide recommendation services to the terminal devices 180 based on compatibility of fashion items. In certain embodiments, the computing device 110 is a server of an e-commerce platform. As shown in FIG. 1, the computing device 110 may include, without being limited to, a processor 112, a memory 114, and a storage device 116. In certain embodiments, the computing device 110 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices.

The processor 112 may be a central processing unit (CPU) which is configured to control operation of the computing device 110. The processor 112 can execute an operating system (OS) or other applications of the computing device 110. In certain embodiments, the computing device 110 may have more than one CPU as the processor, such as two CPUs, four CPUs, eight CPUs, or any suitable number of CPUs. The memory 114 can be a volatile memory, such as the random-access memory (RAM), for storing the data and information during the operation of the computing device 110. In certain embodiments, the memory 114 may be a volatile memory array. In certain embodiments, the computing device 110 may run on more than one memory 114. The storage device 116 is a non-volatile data storage media for storing the OS (not shown) and other applications of the computing device 110. Examples of the storage device 116 may include non-volatile memory such as flash memory, memory cards, USB drives, hard drives, floppy disks, optical drives, or any other types of data storage devices. In certain embodiments, the computing device 110 may have multiple storage devices 116, which may be identical storage devices or different types of storage devices, and the applications of the computing device 110 may be stored in one or more of the storage devices 116 of the computing device 110.

In this embodiments, the processor 112, the memory 114, the storage device 116 are component of the computing device 110, such as a server computing device. In other embodiments, the computing device 110 may be a distributed computing device and the processor 112, the memory 114 and the storage device 116 are shared resources from multiple computers in a pre-defined area.

The storage device 116 includes, among other things, a fashion data retrieving module 120, a fashion database construction application 130, a fashion item compatibility database 140, a fashion item recommendation application 150, and an interface 160. The fashion data retrieving module 120 is configured to retrieve fashion item compatibility data, the fashion database construction application 130 is configured to use the retrieved data to construct the fashion item compatibility database 140, the fashion item recommendation application 150 is configured to use the fashion item compatibility database 140 to provide recommendations in response to a customer's request, and the interface module 160 is configured to provide an interface to an administrator for constructing the fashion compatibility database, or to a customer for interacting with the recommendation system. In the embodiments shown in FIG. 1, the functions of constructing the fashion item compatibility database 140 and using the fashion item compatibility database 140 for recommendation are combined in the storage 116. In other embodiments, the functions of constructing and using the fashion item compatibility database 140 may also be implemented in separated computing devices.

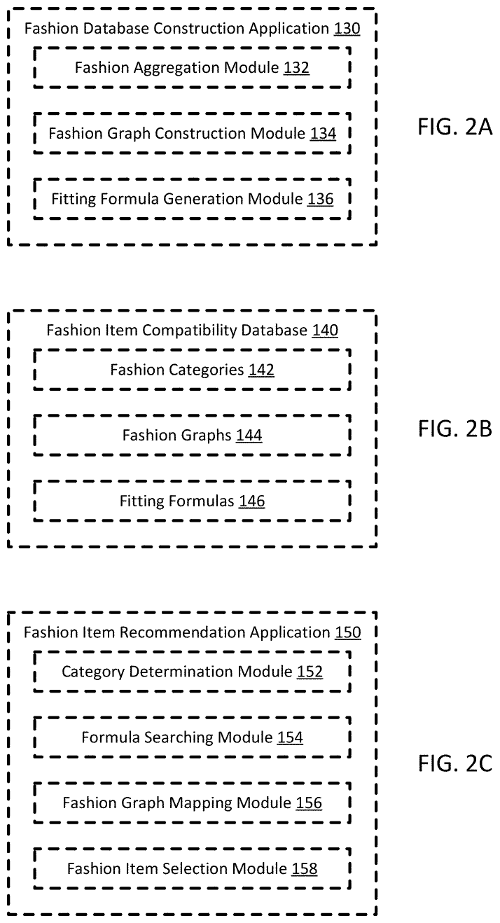

As shown in FIG. 2A, the fashion database construction application 130 includes a fashion aggregation module 132, a fashion graph construction module 134, and a fitting formula generation module 136. As shown in FIG. 2B, the fashion item compatibility database 140 includes fashion categories 142, fashion graphs 144, and fitting formulas 146. As shown in FIG. 2C, the fashion item recommendation application 150 includes a category determination module 152, a formula searching module 154, a fashion graph mapping module 156, and a fashion item selection module 158.

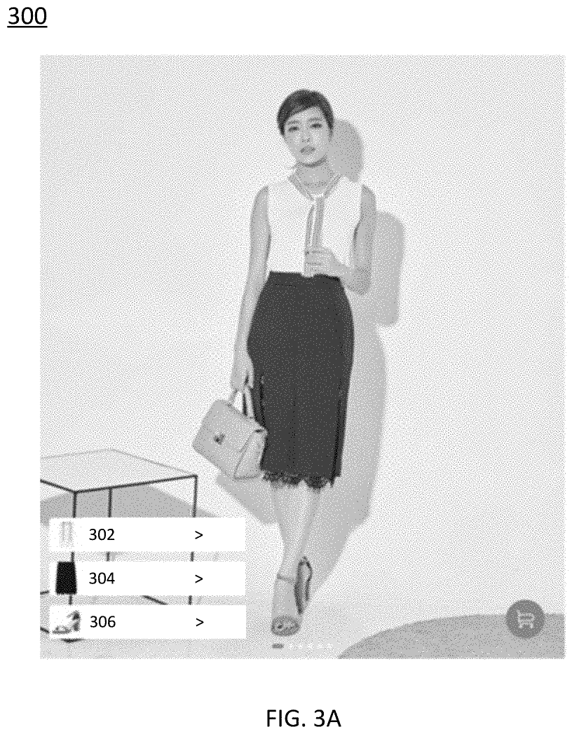

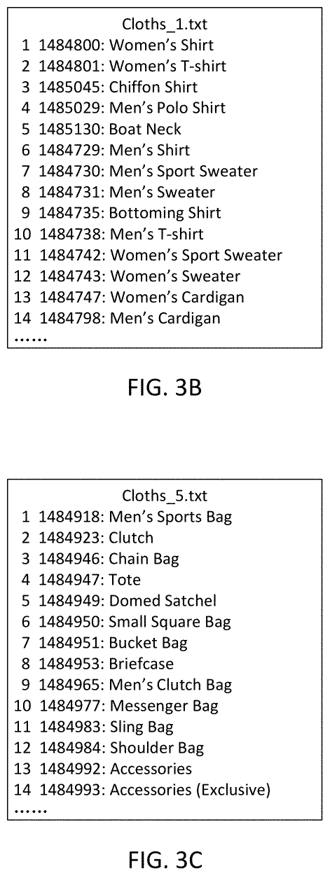

The fashion data retrieving module 120 is configured to retrieve fashion item compatibility data and provide the data to the fashion database construction application 130. In certain embodiments, the fashion data retrieving module 120 is configured to crawl dress data from resources such as ecommerce websites, fashion journals, fashion blogs, etc., each set of the dress data may be a fitting combination, that is, a combination of several fashion items compatible with each other and the combination reflects a fashion style or a fashion occasion. In certain embodiments, the fashion data retrieving module 120 is accessible to product databases of an e-commerce platform, and is configured to retrieve detailed product information of the fashion items from the product databases. In certain embodiments, each fitting combination includes at least three fashion items that are compatible with each other, such as a top cloth, a bottom cloth, a bag, and a pair of shoes. FIG. 3A shows a fitting combination 300 dressed on a model. The fitting combination 300 is for a business occasion, and the business occasion includes fashion items of a vest 302, a skirt 304, and a pair of shoes 306. In certain embodiments, the fashion data retrieving module 120 is configured to collect images, prices, styles, and attributes of the fashion items. In certain embodiments, the fashion data retrieving module 120 is configured to analyze the appearance of attributes for each fashion item. Here attributes may be pieces of information from the SKU inputted by the seller, e.g., the description of the item, including color, season, style, brand, etc. Price may be treated as an attribute and may also be treated differently since it's uniquely different from other attributes. Appearance of attributes may indicate counts of the attributes.

In certain embodiments, the fashion data retrieving module 120 is configured to store the fashion items into files. FIG. 3B and FIG. 3C schematically show part of the stored information. As shown in FIG. 3B and FIG. 3C, each fashion item is identified with an identification number, preferably a stock keeping unit (SKU) of the fashion item. The attributes of the fashion items may include name or title of the fashion item, such as women's shirt, women's T-shirt, Chiffon shirt, men's cardigan, clutch, tote, briefcase, messenger bag, etc. Each fashion item is linked to a fashion style or a fashion occasion provided by the fitting combination. The fashion styles of the fitting combinations include, for example, styles of sports, casual, office, Japanese, Korean, western, British, girls, gentlewomen, concise, nature, street/punk, ethnic, and others; the fashion occasions of the fitting combinations include, for example, occasions of dating, travel, party, sports, campus, business, family, wedding, and others. In addition to the SKU, title or other attributes, fashion style and/or fashion occasion, the images of the fashion items are also stored. Further, the stored information may include price, color, material, etc. of the fashion items. In certain embodiments, some or all of the information of one fashion item may be represented by a vector, each character of the fashion item described above may correspond to one or a few dimensions of the vector. In certain embodiments, the image of the fashion item is represented by a vector, and the vector of the image is used for image similarity search as described below. In certain embodiments, the categories include style and occasion as described above, as well as fit and gender. Fit may include young, tall, thin, etc., and gender includes female and male. Each fashion item may be labeled with corresponding categories of style, occasion, fit, and gender.

The fashion database construction application 130 is configured to process the data of the fashion items provided by the fashion data retrieving module 120, so as to obtain the fashion item compatibility database 140. Specifically, when the fashion aggregation module 132 recognizes the fashion data of the fashion items provided by the fashion data retrieving module 120, the fashion aggregation module 132 is configured to aggregate the fashion data into different style and occasion categories, namely fashion categories 142, and provide the fashion categories 142 to the fashion graph construction module 134. For example, the fashion categories 142 may be, for example, fashion style categories of sports, casual, office, etc. and fashion occasion categories of dating, travel, party, sports, etc. Kindly note the sports style category and the spots occasion category may have a large amount of overlapped fashion items but are different from each other. For the three fashion items shown in FIG. 3A, since the fitting combination 300 is in the business occasion, the three fashion items are added to the business occasion category. In each of the fashion categories 142, the fashion items are aggregated based on their main attribute, such as the attribute of their titles. In certain embodiments, the shoes in the business occasion category may respectively correspond to high heels, flat shoes, sandals, etc. Accordingly, the high heels 306 shown in FIG. 3A are added to the high heels attribute of the business occasion category. Similarly, the vest 302 is added to the vest attribute of the business occasion category, and the skirt 304 is added to the skirt attribute of the business occasion category. When another fitting combination is analyzed, which may include another pair of high heels, the new pair of high heels are also added to the high heels attribute of the business occasion category. By analyzing a large number of fitting combination, the high heels attribute in the business occasion category includes a large number of high heels. In certain embodiments, when the same pair of shoes are included in two different fitting combinations in business occasion, the high heels attribute in the business occasion category would record two separate high heels, which may be linked to different fitting combinations. In certain embodiments, the fashion aggregation module 132 is configured to count the number of fashion items in each attribute of each fashion category as a number value or namely frequency value, and the frequency value of each attribute represents its probability of being seen in a fitting combination in the corresponding fashion category. Accordingly, each fashion category includes a large number of attributes, and each attribute is characterized by a frequency value. In certain embodiments, the frequency value is the number of fashion items in the corresponding attribute. In certain embodiments, the frequency value may also be a percentage between 0-100% or a value between 0-1 corresponding to the number of fashion item in different attributes.

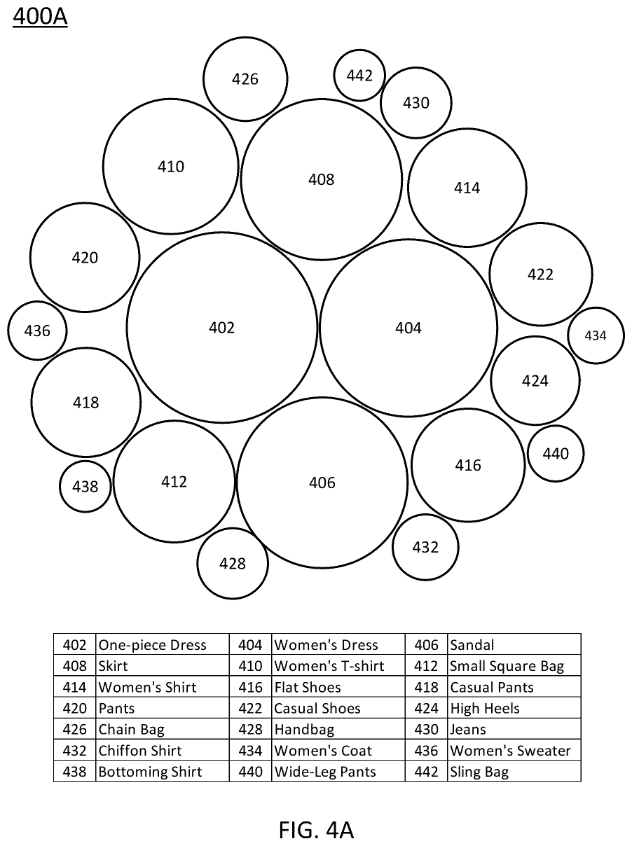

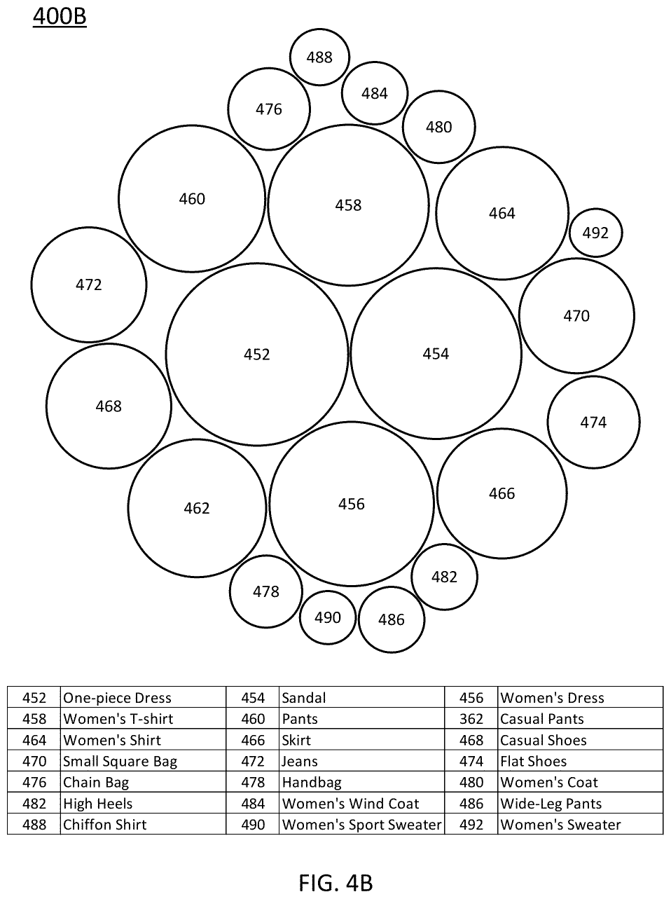

FIG. 4A schematically shows a dating occasion category according to certain embodiments of the present disclosure. As shown in FIG. 4A, after analyzing a large number of fitting combinations for dating occasion, each of the items in those fitting combinations are added to the dating occasion category 400A. The dating occasion category 400A includes, among other things, one-piece dress 402, women's dress 404, sandal 406, skirt 408, women's T-shirt 410, small square bag 412, women's shirt 414, flat shoes 416, casual Pants 418, pants 420, casual shoes 422, high heels 424, chain bag 426, handbag 428, jeans 430, chiffon shirt 432, women's coat 434, women's sweater 436, bottoming shirt 438, wide-leg pants 440, and sling bag 442, etc. The number of times a fashion attribute appears in the dating occasions is counted and recorded, and is schematically shown by the relative area or size of the circles in FIG. 4A. As described above, the counts of the attributes are also named the appearances of the attributes and the counts are proportional to the area of the attributes (or attribute nodes). Accordingly, the one-piece dress 402 is the most often seen attribute in the fitting combinations in dating occasion, although the specific one-piece dress 402, i.e., the specific fashion item, in those fitting combinations may be the same or different from each other. For example, the one-piece dress 402 may include 10 times of one-piece dress SKU 1 since the one-piece-dress having the SKU 1 shows up in 10 fitting combinations in dating occasion, and may include 5 times of one-piece dress SKU 2 since the one-piece-dress having the SKU 2 shows up in 5 fitting combinations in dating occasion. Kindly note the graph shown in FIG. 4A is only a part of the dating occasion category, which includes more fashion items than the ones listed in the graph.

FIG. 4B schematically shows a travel occasion category 400B according to certain embodiments of the present disclosure. Similar to the dating occasion category shown in FIG. 4A, the FIG. 4B shows the attributes 452-492, and each attribute is characterized by a number of fashion items it includes, and the number value is schematically represented by the size of the circles. As shown in FIG. 4A and FIG. 4B, there are overlapped attributes in the two occasion categories, but the number of fashion items in same attribute from the two categories is likely different from each other. For example, the one-piece dress attribute 402 in the travel occasion category 400A and the one-piece dress attribute 452 may include different number of fashion items.

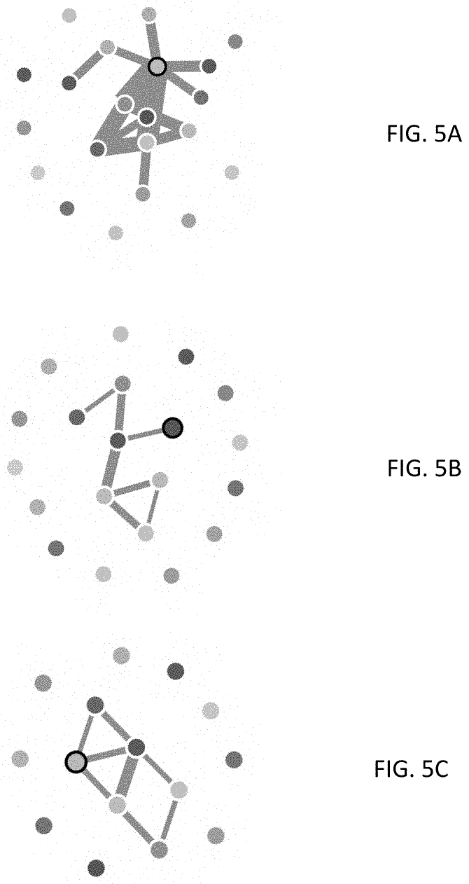

The fashion graph construction module 134 is configured to, when the fashion categories 142 are available, construct fashion graphs 144 from the fashion categories 142, and provide the fashion graphs 144 to the fitting formula generation module 136. In certain embodiments, the fashion graph construction module 134 is configured to construct one fashion graph 144 for each of the fashion categories 142. In each fashion graph 144, the nodes correspond to the attributes of the corresponding fashion category 142. An edge between two attribute nodes indicates the number of co-appearance between one fashion item in the one of the two attribute nodes and another one fashion item in the other one of the two attribute nodes. Here co-appearance means that the two fashion items from the two attribute nodes are appeared in the same fitting combination. In certain embodiments, when the two specific fashion items from the two attribute nodes have been shown in several different fitting combinations, the number of their multiple co-appearances are counted. By this type of graph construction, the connection between two attribute nodes not only reflects the co-appearance of the fashion items from the two attribute nodes, but also provide strong suggestion that some fashion items from the two attributes, although may not have been co-appeared in any fitting combinations before, are likely compatible with each other and could be assigned to a fitting combination. Further, since each of the two attribute nodes includes a large number of fashion items, the above co-appearance are counted for many different combinations, where in each combination, one fashion item is from one of the two attribute nodes, and the other fashion item is from the other one of the two attribute nodes. In certain embodiments, the co-appearance is represented by a co-appearance value, and the co-appearance value is the number of co-appearance of the fashion items from two linked nodes. In certain embodiments, the co-appearance value may also be a percentage or a probability in the range of 0-1 converted from the number of co-appearance. FIGS. 5A-5C schematically show three fashion graphs 144 corresponding to dating occasion category, sports occasion category, and casual style category, respectively. Each dot in the fashion graphs 144 represents an attribute in the categories, and the thickness of each edge represents co-appearance of fashion items from the two connected attributes. The thicker the edge, the higher the number of co-appearance of the fashion items from the connected attributes. Kindly note FIGS. 5A-5C are used to schematically show a broad pool of nodes, and the discrete nodes are meant to show their independence from the style and occasion attributes/nodes. For example, we may have fit nodes in addition to the style/occasion nodes. In certain embodiments, the disclosure can also construct a graph containing only style/occasion nodes, but the incorporation of other nodes in the graph are helpful for providing further information for the system and those information may be used for other purposes other than the ones described in this disclosure.

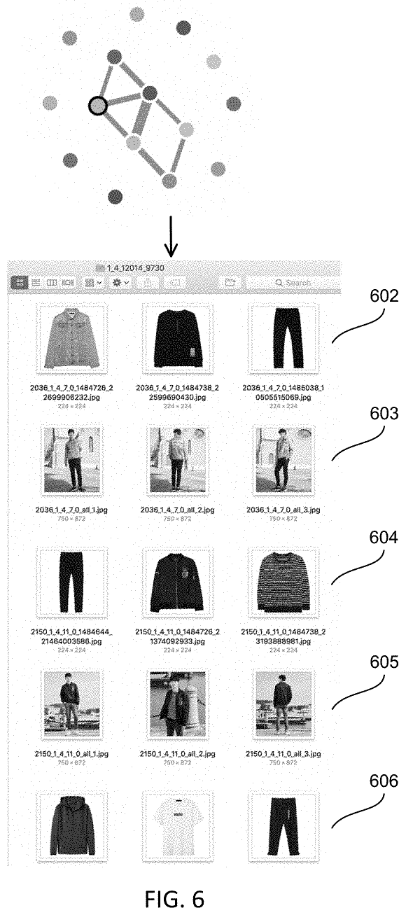

The fitting formula generation module 136 is configured to, when the fashion graphs 144 are available, generate the fitting formulas 146 based on the fashion graphs 144. Each fitting formulas 146 generally includes three or four fashion items corresponding to three or four attributes from a fashion graph 144. In certain embodiments, some fitting formulas 146 may each include two fashion items or more than four fashion items. FIG. 6 schematically shows a process of generating the fitting formulas. As shown in FIG. 6, the casual style graph includes attribute nodes and edges. The fitting formula generating module 136 is configured to found multiple fitting combinations, each combination corresponds to three or four connected attributes nodes. A representing fashion item is selected from each of the attribute nodes. Accordingly, the fitting formulas 602, 604 and 606 are generated.

In certain embodiments, the selection of the connected nodes for generating fitting formulas are based on the number of fashion items the attributes include and the number of connections of the edges. The stronger the edge connection, the higher possibility the nodes connected by the edge are selected.

In certain embodiments, the co-appearance value of the edges of a fashion graph is ranked, and each of the fitting formulas is derived from one of the highest ranked edges. For example, when the highest ranked edge is found, a first node and a second node connected by the highest ranked edge are selected, and from one of the first and second nodes, a third nodes is further selected. The third nodes has a higher co-appearance value to the first or second nodes than co-appearance values of any other nodes to the first or second nodes. The representing fashion items from the first, second and third nodes form a fitting formula. Subsequently, the second highest ranked edge is found, and another fitting formula can be formed.

In certain embodiments, every three (or four) connected nodes are set as a preliminary fitting formula. The co-appearance values of the edges in each preliminary fitting formulas are added together to obtain a summarized co-appearance value. The summarized co-appearance values of the preliminary fitting formulas are ranked, and the top ranked preliminary fitting formulas are selected as the fitting formulas of the corresponding fashion graph or fashion category.

In certain embodiments, the fashion items from some or all of the fitting formulas are dressed on a model, the dressed models are shown, for example, as 603 and 605. The images of the fashion items and optionally the images of the fashion items dressed on the model are stored as part of the fitting formulas 146. In certain embodiments, restrictions are applied to the generation of the fitting formulas 146. For example, the fitting formula generation module 136 may provide conflicting information between the attributes, and prevent placing the conflicted attributes into one fitting formula. For example, sports pants and casual pants may be set as conflicting attributes, and a sports pant fashion item would not be placed together with a casual pant fashion item in the same fitting formula. In certain embodiments, the fitting formula generation module 136 may also define the attributes into groups of top clothes, bottom clothes, shoes, and accessories, and the fashion formula may be required to include only one of those defined groups.

The fashion item compatibility database 140 stores data generated by the fashion database construction application 130. As described above, the fashion categories 142, as shown in FIG. 4A and FIG. 4B, includes aggregated attributes. The attributes are extracted from the fashion data retrieved by the fashion data retrieving module 120, mainly fitting combination data from other sources. Each attributes includes multiple fashion items, and the number of the fashion items corresponds to their appearance in the retrieved data, especially the fitting combinations. Therefore, the number of the fashion items in each attribute indicates the probability that the attribute appears in a fitting combination of the corresponding fashion category. Kindly note that the same fashion item in the same attribute may be counted several times if the fashion item appeared in several fitting combinations corresponding to the fashion category.

The fashion graphs 144 are derived from the fashion categories 142. Referring back to FIGS. 5A-5C, each fashion category 142 has a corresponding fashion graph 144. The fashion graph includes fashion attributes as nodes, and the edges between two attribute nodes represent the co-appearance of fashion items from the two connected attribute nodes.

The fitting formulas 146 are fitting combinations derived from the fashion graphs 144. Referring back to FIG. 6, the connected three attribute nodes or four attribute nodes having edge connections in the fashion graph 144 are extracted as fitting formulas. Each formula 146 includes a representative fashion item from each of the attribute nodes. Each formula 146 includes images of the representative fashion items compatible with each other, and optionally includes images of a models dressed in the representative fashion items. For example, given a node 2, a fitting formula 1-2-3 may be generated since the node 2 has the strongest connections to node 1 and node 3; given a node 3, a fitting formula 2-3-4 may be generated since the node 3 has the strongest connections to node 2 and node 4; given a node 1, a fitting formula 2-1-4 may be generated since the node 1 has the strongest connections to node 2 and node 4. In certain embodiments, one or more of the other strong connections may also be picked up as fitting formulas. For example, for the given node 1, a fitting formula 2-1-5 may be generated since the node 1 has strong connections to node 2 and node 5. Although the nodes 1-5 connections is not as strong as the nodes 2-1 and nodes 1-4 connection, it is stronger than connections between the node 1 and the nodes other than 1, 4 and 5. In certain embodiments, a surprise fitting formula may be created, where a random weak nodes connection is selected as part of the fitting formula. For example, for the given node 1, a fitting formula 2-1-9 may be generated, where the connection between nodes 1 and 9 is weak, and the node 9 is randomly selected from multiple nodes that have weak connections with the node 1 (but the connections may still greater than a predetermined threshold).

When the fashion item compatibility database 140 is available, the fashion item recommendation application 150 is configured to provide recommendation services to the customers using the database. Kindly note the computing device 110 does not have to include the fashion database construction application 130, whose function could be performed elsewhere, and the fashion item compatibility database 140 can be transferred to or is accessible to other computing devices, such that the other computing devices can use the fashion item compatibility database 140 for recommendation purpose.

The fashion item recommendation application 150 includes the category determination module 152, the formula searching module 154, the fashion graph mapping module 156, and the fashion item selection module 158. The category determination module 152 is configured to, upon receiving a request from a customer in regard to a fashion item, determine the fashion category for the fashion item. In certain embodiments, the customer may select the fashion item from the e-commerce platform, and the category determination module 152 is able to determine category based on the attribute labels of the fashion item on the e-commerce platform. The attribute labels may be, for example, T-shirt or pants, and the determined top fashion category or top fashion categories include an attribute corresponding to the attribute label of the fashion item, and the attribute in the top fashion categories has a highest number of fashion items included therein. In certain embodiments, the category determination module 152 is configured to use a convolutional neural network (CNN) classifier to determine the fashion category based on an image of the fashion item. In certain embodiments, the category determination module 152 may also allow the customer to input his preference on fashion category or categories. After obtaining the top category or categories from the labels or the CNN, the category determination module 152 is further configured to send the determined fashion category or categories to the formula searching module 154.

In certain embodiments, when the labels of the fashion item do not match the attributes in the fashion category 142, the category determination module 152 may also find top fashion categories that have attributes similar to the labels, where the attributes have high frequency in the fashion categories. In certain embodiments, the user may also choose one or a few fashion categories.

In an example, the customer finds a skirt on the ecommerce platform, and plans to have a fitting combinations for the skirt. When the customer requests recommendation from the fashion item recommendation application 150, the category determination module 152 may find the dating occasion category and the travel occasion category, because the number of fashion items in the skirt attribute of the dating occasion category is greater than the number of fashion items in the skirt attribute of any other fashion category, and the number of fashion items in the skirt attribute of the travel occasion category ranks the second to the dating occasion category. In certain embodiments, the category determination module 152 may provide the top fashion category, top 2 fashion category, top 3 fashion category, or any other predetermined number of top fashion categories for the requested fashion item.

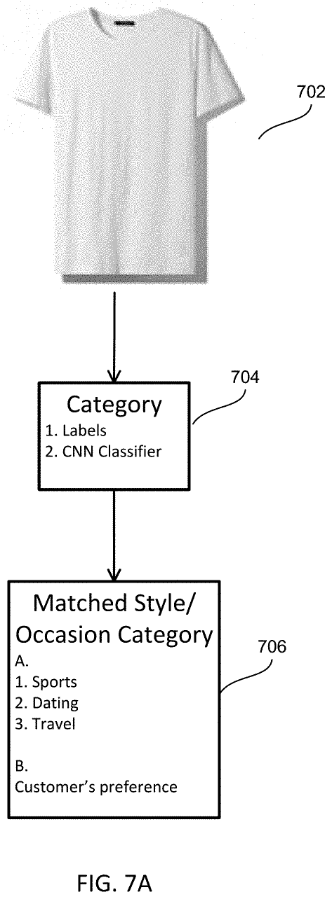

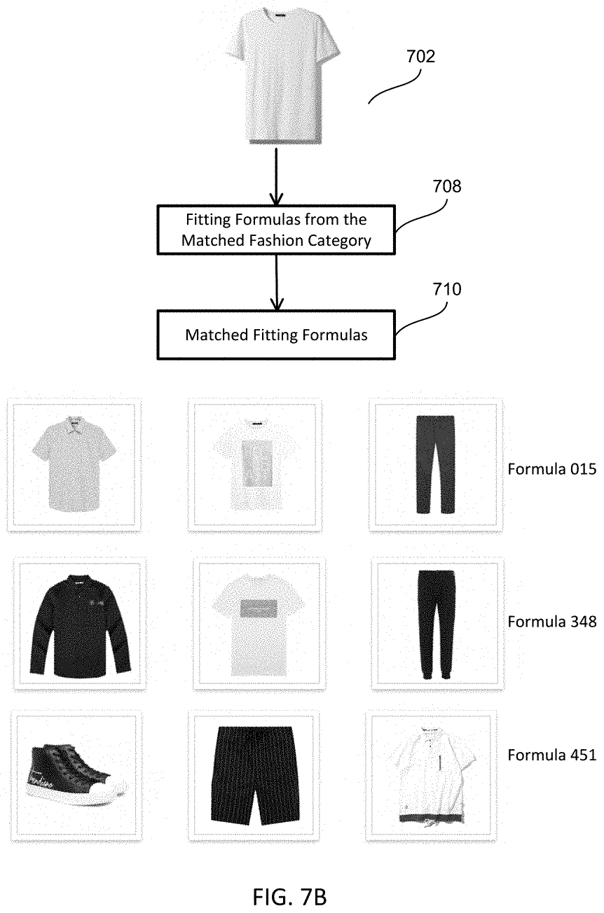

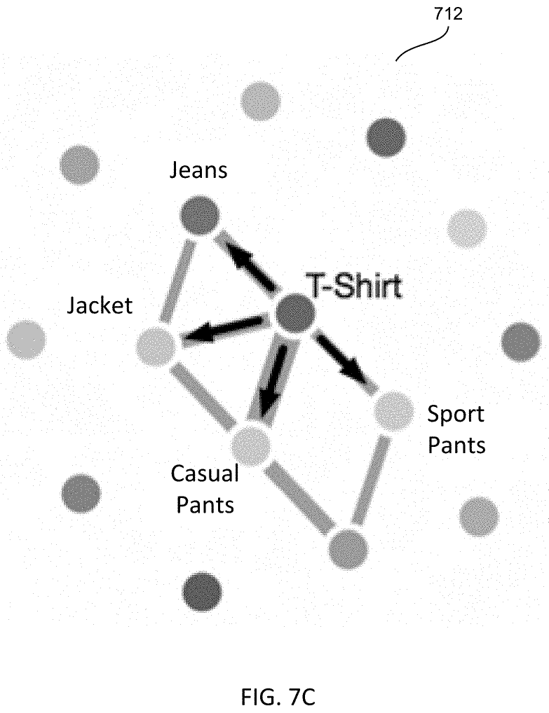

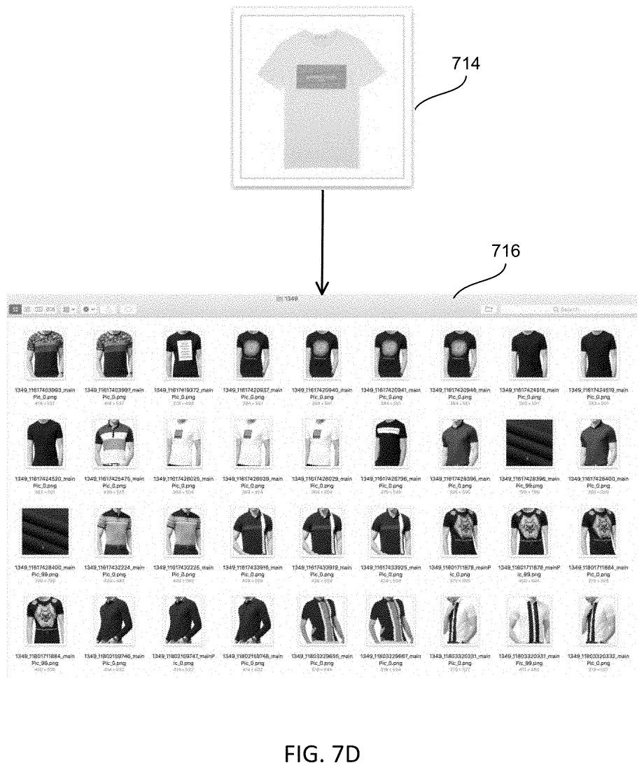

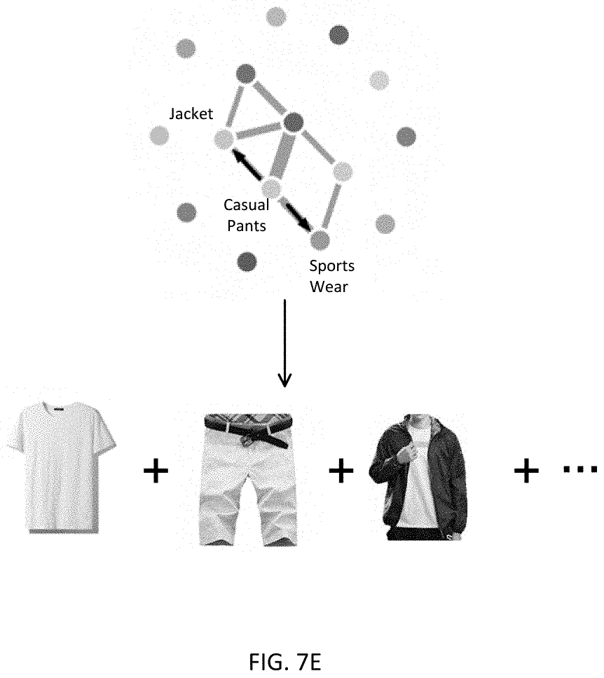

FIG. 7A schematically depicts the function of the category determination module 152. As shown in FIG. 7A, the customer requests recommendation in regard to the fashion item 702. Based on the label of the fashion item 702 or through CNN classifier using the image of the fashion item 702, the category 704 is determined. The category 704 corresponds to the style or occasion categories 706 or namely fashion categories, which could be the sports occasion category, dating occasion category, and travel occasion category. The fashion categories may have the forms as shown in FIGS. 4A and 4B.

The formula searching module 154 is configured to, upon receiving the determined fashion categories, perform a similarity search using the image of the requested fashion item against the images in the fitting formulas 146 of the fashion categories, obtain a predetermined number of fitting formulas 146 that have the best image matches, and send the fitting formulas to the fashion graph mapping module 156. For example, if the determined top three fashion categories have 150, 110, and 120 corresponding fitting formulas, each fitting formulas have images of the respective representative fashion items, the formula search module 154 would compare the image of the requested fashion item with the images in the total of 380 fitting formulas, ranks the fitting formulas based on the image similarity, and select the predetermined number of fitting formulas from the top of the rank list. In certain embodiments, the formula searching 154 only performs similarity search between the image of the requested fashion item to the images of fitting formulas of one fashion category. In certain embodiments, for image similarity comparison, the formula search module 154 may choose to compare the image of the requested fashion item only to the fashion items in the fitting formulas that have similar attributes, such as comparing the skirt only to the fashion item in the fitting formulas that are bottom wear.

FIG. 7B schematically depicts the function of the formula search module 154. As shown in FIG. 7B, the formula search module 154 performs image similarity search of the requested fashion item 704 against the images of the fashion items stored in the fitting formulas 708 that match with the determined fashion category, so as to obtain matched fitting formulas 710. In one example, the matched fitting formulas include formula 015, formula 348, and formula 451.

The fashion graph mapping module 156 is configured to, upon receiving the top fitting formula or top fitting formulas from the formula searching module 154, map each fitting formula to the fashion graph of the determined fashion category, and send the matched fashion graph to the fashion item selection module 158. FIG. 7C schematically illustrates mappings of possible top fitting formulas to the corresponding travel fashion graph 712 according to certain embodiments of the present disclosure. As shown in FIG. 7C, different mapping routes are available from the node T-shirt corresponding to the possible top fitting formulas. For example, for the formula 348, the fashion graph mapping module 156 maps the formula 348 to the travel fashion occasion graph 712, and matches the attributes T-shirt, jacket, and sports pants.

The fashion item selection module 158 is configured to, for each of the fashion items listed in the fitting formula, find the corresponding attribute node in the fashion graph, and select a recommendation fashion item from a list of recommendation fashion items from the attribute node. FIG. 7D schematically depicts the function of the fashion item selection module 158. When the mapping between the fitting formula 348 and the fashion graph is made, each fashion item in the fitting formula 348 corresponds to a corresponding attribute node. For the T-shirt 714 in the fitting formula 348, the corresponding node is the T-shirt attribute node. The T-shirt attribute node includes a plurality of fashion items 716. Each of the fashion items 716 has a corresponding SKU in the e-commerce platform. By selecting one of the fashion items 716, one fashion item in the fitting formula 348 is determined. By repeating the process for each of the fashion items in the fitting formula 348, a set of dresses is recommended to the customer. FIG. 7E schematically shows selection of three fashion items of a fitting formula based on the matched part of fashion graph. As shown in FIG. 7E, the customer can also select more items based on the matched fashion graph, such as expending to one or more connected attribute nodes from attribute nodes matching the fitting formula.

Referring back to FIG. 1, the interface 160 is configured to provide an interface for an administrator to manage the fashion data retrieving module 120 and the fashion database construction application 130, so as to construct the fashion item compatibility database 140; and configured to provide an interface for the customer or user to request a fashion item recommendation by interacting with the executed fashion item recommendation application 150, so as to obtain a set of fitting combinations.

The network 170 is configured to facilitate communication between the terminal devices 180 and the computing device 110. In certain embodiments, the network 170 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of network.

The terminal devices 180 may be a terminal operated by a customer. The form of the terminal device is not particularly limited, and in some embodiments, portable devices (for example, smartphones, tablet devices, and laptops) or stationary devices (for example, desktop computers) may be used as the terminal devices 180. The terminal device 180 may connect to the network 170 via any technique, such as wired or wireless connections. The interface module 160, when being executed, is able to provide an interface, such as a graphic user interface (GUI), to the terminal devices 180.

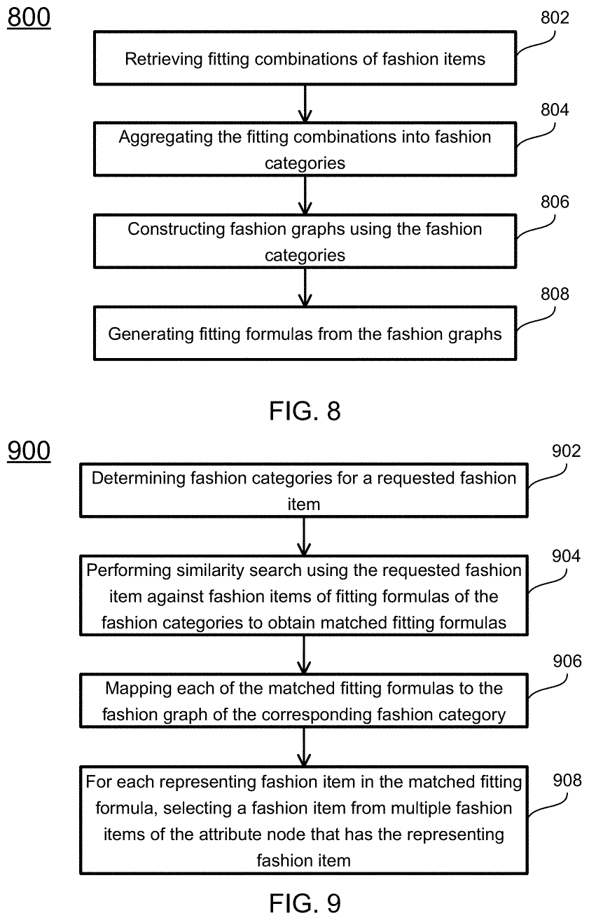

FIG. 8 schematically depicts a method for fashion item compatibility database construction according to certain embodiments of the present disclosure. In certain embodiments, the method is implemented by the computing device 110 shown in FIG. 1. It should be particularly noted that, unless otherwise stated in the present disclosure, the steps of the method may be arranged in a different sequential order, and are thus not limited to the sequential order as shown in FIG. 8.

As shown in FIG. 8, at procedure 802, upon receiving an instruction from an administrator, the fashion data retrieving module 120 retrieves fashion item compatibility data, and sends the data to the fashion aggregation module 132. The fashion item compatibility data includes fitting combinations, and each fitting combination has a dress style or is suitable for an occasion. The number of fashion items in each fitting combination is generally three or four, and the fashion items in each fitting combination are compatible with each other. In certain embodiments, the fitting combinations are crawled from e-commerce websites. In certain embodiments, the fashion data retrieving module 120 also retrieves data of the fashion items from a product database provided by an e-commerce platform. In certain embodiments, the fashion data retrieving module 120 also processes the data, for example cleans or removes redundant or unreliable data, organizes the data according to its characters, and converting certain data into vectors or other suitable forms.

At procedure 804, in response to receiving the retrieved fashion item compatibility data, the fashion aggregation module 132 aggregates the data into different fashion categories, and send the fashion categories to the fashion graph construction module 134. The fashion categories include style categories and occasion categories, and the fashion items belonging to one of the fashion categories are grouped into attributes, each attribute group includes fashion items having the same high level attributes, such as attributes of T-shirt, jeans, pants. The number of fashion items in each attribute group is counted.

At procedure 806, the fashion graph construction module 134, upon receiving the fashion categories, constructs a fashion graph for each of the fashion categories, and sends the constructed fashion graphs to the fitting formula generation module 136. For each fashion category, the fashion graph construction module 134 treats the attributes in the fashion category as nodes. For the fashion items in two of the nodes, the fashion graph construction module 134 computes the co-appearance of one fashion item in one node with one fashion item in the other node, by counting the times the two fashion items shown in the same fitting combination. The co-appearance of the other fashion items from the two attribute nodes are computed the same way, and summarized. The summarized value is used as the edge between the two attribute nodes.

At procedure 808, the fitting formula generation module 136, upon receiving the fashion graphs, generates fitting formulas based on the attribute nodes and the edges for each of the fashion graphs. A representative fashion item is selected for each of the attributes, for example, because the representative fashion item appears the most times in the attribute node. The fitting formulas generally includes three or four representing fashion items, and each representing fashion item represents an attribute node. When three or four attribute nodes are linked by edges, their representative fashion items are grouped together as one of the fitting formulas.

The fashion categories 142, the fashion graphs 144 and the fitting formulas 146 generated in the above method are stored in the fashion item compatibility database 140 of the computing device 110 for being used in processing customers' request. In certain embodiments, the fashion item compatibility database 140 includes other information of the related fashion items, for example, the identification or SKU of the fashion items, the images of the fashion items, and optionally the price, the material, the color, the size, etc. of the fashion items.

FIG. 9 schematically depicts a method for fashion item recommendation according to certain embodiments of the present disclosure. In certain embodiments, the method is implemented by the computing device 110 shown in FIG. 1. It should be particularly noted that, unless otherwise stated in the present disclosure, the steps of the method may be arranged in a different sequential order, and are thus not limited to the sequential order as shown in FIG. 9.

The method of FIG. 9 is performed when the fashion item compatibility database 140 is available. As shown in FIG. 9, at procedure 902, upon receiving an fashion item from a customer that he needs fitting recommendation based on the fashion item, the category determination module 152 determines one or a few fashion categories based on the query fashion item, and sends the fashion categories to the formula searching module 154. In certain embodiments, the fashion item itself includes labels of styles and occasions it belongs to, which are used directly by the category determination module 152 to determine the fashion categories. In certain embodiments, the category determination module 152 uses a CNN classifier to process the image of the requested fashion item so as to obtain the one or the few fashion categories. In certain embodiments, the category determination module 152 may also determine the fashion category based on the customer's input.

At procedure 904, the formula searching module 154, upon receiving the one or the few fashion categories, performs image similarity search using the image of the requested fashion item against the images of the fashion items in the fitting formulas of the corresponding fashion category or categories to obtain best matches, and sends the fitting formulas having the best matches to the fashion graph mapping module 156. In certain embodiments, CNN features or color histograms of the images are used for the similarity search.

At procedure 906, the fashion graph mapping module 156, upon receiving the fitting formulas from the formula searching module 154, maps each of the fitting formulas to the fashion graph of the fashion category enclosing the fitting formula, and sends the mapping result to the fashion item selection module 158.

At procedure 908, the fashion item selection module 158, upon receiving the mapping result between the fitting formula and the fashion graph, chooses an attribute node corresponding to each of the fashion items in the fitting formula, and selects one of the fashion items linked to the attribute nodes according to the customers instruction. The process is repeated for each of the fashion items in the fitting formula, such that a complete set of fashion items is obtained, where the fashion items are compatible with each other in style or occasion.

In certain aspects, the present disclosure relates to a non-transitory computer readable medium storing computer executable code. In certain embodiments, the computer executable code may be the software stored in the storage device 116 shown in FIG. 1. The computer executable code, when being executed, may perform one of the methods described above. In certain embodiments, the non-transitory computer readable medium may include, but not limited to, the storage device 116 of the computing device 110 as described above, or any other storage media of the computing device 110.

Certain embodiments of the present disclosure, among other things, have the following beneficial advantages: (1) Appearance frequency: Attributes of a style or occasion category are represented by the number of fashion item appearance in the attribute. Accordingly, when a customer provides a fashion item as a query and a corresponding attribute of the query fashion item is determined, the fashion categories the customer is likely to be interested in can be retrieved based on the appearance frequency of the corresponding attribute. (2) Visual feature: The system of the disclosure constructs fitting formulas from the fashion graph, and the fitting formulas includes images of the fashion items therein. By visual search using images of the query fashion item against the fashion item images of the fitting formulas, the system provides vivid views of the fitting formulas at the early stage of fashion item recommendation and retains the critical visual feature of the query fashion item. (2) Co-appearance frequency: Co-appearance of paired fashion items in fitting combination data are counted and reflected in the fashion graphs by edges. The fitting formulas of a fashion categories reflects the frequency of the co-appearance. By determining the fitting formulas of the query fashion item, and mapping the fitting formula back to the fashion graph, the co-appearance frequency of fashion items are maintained, so as to find fashion items that are likely to co-appear with the query fashion item. (4) Large fashion item selection pool: The fitting formulas are matched to the attribute nodes in the fashion graph, and each attribute node is linked to a large number of fashion items with SKUs, which forms a large fashion item pool for the customer to select from. Therefore, when a fitting formula is determined, the system can provide large number of products on the e-commerce platform for each fashion item in the fitting formula. By this way, the customer has high flexibility for selecting a fashion item from many fashion items that have similar characters for each one of the fashion items in the fitting formula.

In summary, by the combination of fashion item appearance frequency, co-appearance of fashion items, visual similarity search, and a broad range of fashion items to choose from for each selected fashion item, the embodiments of the present disclosure provide high efficiency and high flexibility systems and methods for recommending fashion items to the customers, and the recommended fashion items are compatible with each other.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for recommending a set of fashion items, comprising:
providing, by a computing device, a plurality of fashion categories, wherein each of the fashion categories comprises a plurality of fashion attributes, and each of the fashion attributes has a frequency value representing a number of fashion items contained in the attribute;
providing, by the computing device, a fashion graph corresponding to each of the fashion categories, wherein nodes of the fashion graph correspond to the fashion attributes of the fashion category, and each edge of the fashion graph has a co-appearance value representing a number of co-appearance of the fashion items from two of the nodes connected by the edge;
providing, by the computing device, a plurality of fitting formulas for each of the fashion categories, each of the fitting formulas comprising a number of fashion items;
receiving, by the computing device, a query fashion item;
selecting, by the computing device, one of the fashion categories as a selected fashion category, wherein the query fashion item corresponds to a query fashion attribute, the frequency value of the query fashion attribute in the selected fashion category is greater than the frequency value of the query fashion attribute in the other of the fashion categories;
performing, by the computing device, a similarity search between image of the query fashion item and images of the fashion items in the fitting formulas of the selected fashion category, to obtain at least one searched fitting formula, the image of the query fashion item and one of the images of the fashion items in the searched fitting formulas having a highest image similarity;
mapping, by the computing device, the searched fitting formula to the fashion graph of the selected fashion category to obtain matched nodes, the matched nodes corresponding to the fashion items in the searched fitting formula; and
recommending, by the computing device, the set of fashion items, wherein each of the set of fashion items is selected from a plurality of fashion items in one of the matched nodes.

2. The method of claim 1, wherein the fashion categories, the fashion graphs, and the fitting formulas are provided by:
retrieving fitting combinations, each fitting combination comprising a plurality of fashion items compatible with each other;
aggregating the fashion items from the fitting combinations according to their fashion styles or fashion occasions to obtain the fashion categories, each of the fashion categories corresponding to one of the fashion styles or fashion occasions;
constructing the fashion graphs from the fashion categories by converting the fashion attributes in the fashion categories to the nodes in the fashion graph, and calculating the co-appearance value between the nodes to characterize the edges; and
generating the fitting formulas based on co-appearance values in corresponding one of the fashion graph.

3. The method of claim 1, wherein the fashion styles comprise sports style, casual style, office style, Japanese style, Korea style, western style, British style, girly, and punk, and the fashion occasions comprise dating occasion, travel occasion, party occasion, family occasion, and wedding occasion.

4. The method of claim 1, wherein the attributes comprise skirts, pants, shirt, T-shirt, sweater, cardigan, boat neck, sports bag, clutch, tote, satchel, bucket bag, briefcase, and accessories.

5. The method of claim 1, wherein the fashion items in the attributes of the fashion categories are characterized by their identifications, images, prices, styles and attributes.

6. The method of claim 5, wherein the identifications are stock keeping units (SKUs).

7. The method of claim 5, wherein the identifications, images, prices, styles and attributes of the fashion items are represented by a vector having a plurality of dimensions.

8. The method of claim 1, wherein the similarity search is performed using color histogram.

9. The method of claim 1, wherein the step of selecting one of the fashion categories as the selected fashion category is performed by convolutional neural network (CNN) using the image of the query fashion item.

10. The method of claim 1, wherein each of the fitting formulas comprises at least three fashion items, and each of the at least three fashion items exclusively corresponds to one of a top wear, a bottom wear, an outwear, a pair of shoes, and an accessory.

11. A system for recommending a set of fashion items comprising a computing device, the computing device comprising a processor and a storage device storing computer executable code, wherein the computer executable code, when executed at the processor, is configured to:
provide a plurality of fashion categories, wherein each of the fashion categories comprises a plurality of fashion attributes, and each of the fashion attributes has a frequency value representing a number of fashion items contained in the attribute;
provide a fashion graph corresponding to each of the fashion categories, wherein nodes of the fashion graph correspond to the fashion attributes of the fashion category, and each edge of the fashion graph has a co-appearance value representing a number of co-appearance of the fashion items from two of the nodes connected by the edge;
provide a plurality of fitting formulas for each of the fashion categories, each of the fitting formulas comprising a number of fashion items;
receive a query fashion item;
select one of the fashion categories as a selected fashion category, wherein the query fashion item corresponds to a query fashion attribute, the frequency value of the query fashion attribute in the selected fashion category is greater than the frequency values of the query fashion attribute in the other of the fashion categories;
perform a similarity search between image of the query fashion item and images of the fashion items in the fitting formulas of the selected fashion category, to obtain at least one searched fitting formula, the image of the query fashion item and one of the images of the fashion items in the searched fitting formulas having a highest image similarity;
map the searched fitting formula to the fashion graph of the selected fashion category to obtain matched nodes, the matched nodes corresponding to the fashion items in the searched fitting formula; and
recommend the set of fashion items, wherein each of the set of fashion items is selected from a plurality of fashion items in one of the matched nodes.

12. The system of claim 11, wherein the computer executable code is configured to provide the fashion categories, the fashion graphs, and the fitting formulas by:
retrieving fitting combinations, each fitting combination comprising a plurality of fashion items compatible with each other;
aggregating the fashion items from the fitting combinations according to their fashion styles or fashion occasions to obtain the fashion categories, each of the fashion categories corresponding to one of the fashion styles or fashion occasions;
constructing the fashion graphs from the fashion categories by converting the fashion attributes in the fashion categories to the nodes in the fashion graph, and calculating the co-appearance value between the nodes to characterize the edges; and
generating the fitting formulas based on the co-appearance values in corresponding one of the fashion graphs.

13. The system of claim 11, wherein the fashion styles comprise sports style, casual style, office style, Japanese style, Korea style, western style, British style, girly, and punk, the fashion occasions comprise dating occasion, travel occasion, party occasion, family occasion, and wedding occasion, and the attributes comprise skirts, pants, shirt, T-shirt, sweater, cardigan, boat neck, sports bag, clutch, tote, satchel, bucket bag, briefcase, and accessories.

14. The system of claim 11, wherein the fashion items in the attributes of the fashion categories are characterized by their identifications, images, prices, styles and attributes, and the identifications comprise stock keeping units (SKUs).

15. The system of claim 14, wherein the identifications, images, prices, styles and attributes of the fashion items are represented by a vector having a plurality of dimensions.

16. The system of claim 11, wherein the similarity search is performed using color histogram.

17. The system of claim 11, wherein the computer executable code is configured to select the one of the fashion categories by convolutional neural network (CNN) using the image of the query fashion item.

18. The system of claim 11, wherein each of the fitting formulas comprises at least three fashion items, and each of the at least three fashion items exclusively corresponds to one of a top wear, a bottom wear, an outwear, a pair of shoes, and an accessory.

19. A non-transitory computer readable medium storing computer executable code, wherein the computer executable code, when executed at a processor of a computing device, is configured to:
provide a plurality of fashion categories, wherein each of the fashion categories comprises a plurality of fashion attributes, and each of the fashion attributes has a frequency value representing a number of fashion items contained in the attribute;
provide a fashion graph corresponding to each of the fashion categories, wherein nodes of the fashion graph correspond to the fashion attributes of the fashion category, and each edge of the fashion graph has a co-appearance value representing a number of co-appearance of the fashion items from two of the nodes connected by the edge;
provide a plurality of fitting formulas for each of the fashion categories, each of the fitting formulas comprising a number of fashion items;
receive a query fashion item;
select one of the fashion categories as a selected fashion category, wherein the query fashion item corresponds to a query fashion attribute, the frequency value of the query fashion attribute in the selected fashion category is greater than the frequency values of the query fashion attribute in the other of the fashion categories;
perform a similarity search between image of the query fashion item and images of the fashion items in the fitting formulas of the selected fashion category, to obtain at least one searched fitting formula, the image of the query fashion item and one of the images of the fashion items in the searched fitting formulas having a highest image similarity;
map the searched fitting formula to the fashion graph of the selected fashion category to obtain matched nodes, the matched nodes corresponding to the fashion items in the searched fitting formula; and
recommend the set of fashion items, wherein each of the set of fashion items is selected from a plurality of fashion items in one of the matched nodes.

20. The non-transitory computer readable medium of claim 19, wherein the computer executable code is configured to provide the fashion categories, the fashion graphs, and the fitting formulas by:
retrieving fitting combinations, each fitting combination comprising a plurality of fashion items compatible with each other;
aggregating the fashion items from the fitting combinations according to their fashion styles or fashion occasions to obtain the fashion categories, each of the fashion categories corresponding to one of the fashion styles or fashion occasions;
constructing the fashion graphs from the fashion categories by converting the fashion attributes in the fashion categories to the nodes in the fashion graph, and calculating the co-appearance value between the nodes to characterize the edges; and
generating the fitting formulas based on the co-appearance values in corresponding one of the fashion graphs.
